(19) United States
(12) Patent Application Publication
(10) Pub. No.: US 2003/0184573 A1
(43) Pub. Date: Oct. 2, 2003

(54) Network terminal apparatus and method of presenting display thereon

(76) Inventor: Katsuhisa Watanabe, Kawasaki-shi (JP)

Correspondence Address: FITZPATRICK CELLA HARPER & SCINTO, 30 ROCKEFELLER PLAZA, NEW YORK, NY, 10112, US

(21) Appl. No.: 09/545,188

(22) Filed: Apr. 7, 2000

(30) Foreign Application Priority Data
Apr. 9, 1999 (JP) 11-103221

(51) Int. Cl. G09G 5/00

(52) U.S. Cl. 345/700

(57) ABSTRACT

The connection status of each of various peripheral devices connected to a network is found and, on the basis of the connection status found, a plurality of functions implemented by one or a plurality of peripheral devices are managed, function by function, together with settings information of the peripheral device or devices which implement the functions. Each managed function is displayed in the form of an icon. Settings information (903) of a peripheral device in regard to a function (901) selected by the user from among functions displayed as icons is displayed in the proximity of the icon of the function.

### FIELD OF THE INVENTION

This invention relates to a network terminal apparatus and a method of presenting a display on this apparatus.

### BACKGROUND OF THE INVENTION

When a function such as the inputting (scanning) or copying of an image from a server is implemented by a client in a conventional network system in which the image input server and a plurality of clients are connected via a network, it is necessary to present a display such as a settings dialog screen at the client apparatus in order that the client may check such settings information as the particular image input device to be used, the particular printer to be used, etc.

A problem with the prior-art arrangement described above is that when the client uses various devices on the network, the client cannot check the settings information concerning the devices to be used without first performing an operation such as displaying a settings screen or executing the processing that is actually for using the devices. This is very inconvenient as far as the user is concerned.

### SUMMARY OF THE INVENTION

Accordingly, an object of the present invention is to provide a network terminal apparatus and a method of presenting a display thereon whereby it is possible to display, function by function and without performing a complicated operation, settings information concerning peripheral devices connected to a network.

Another object of the present invention is to provide greater user convenience by displaying settings information, which concerns the functions implemented by peripheral devices connected to a network, in close proximity to icons that represent the functions.

According to the present invention, the foregoing objects are attained by providing a network terminal apparatus comprising: search means for finding the connection status of each of various peripheral devices connected to a network; management means for managing settings information of a peripheral device for each function implemented by the peripheral device, based upon the connection status found by the search means; icon display means for displaying, in icon form, each function managed by the management means; and settings information display means for displaying settings information concerning a peripheral device in regard to a function selected by a user from among the functions displayed by the icon display means.

Further, according to the present invention, the foregoing objects are attained by providing a method of presenting a display on a network terminal apparatus, the method comprising: a search step of finding the connection status of each of various peripheral devices connected to a network; a management step of managing settings information of a peripheral device for each function implemented by the peripheral device, based upon the connection status found at the search step; an icon display step of displaying, in icon form, each function managed at the management step; and a settings information display step of displaying settings information concerning a peripheral device in regard to a function selected by a user from among the functions displayed at the icon display step.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a diagram illustrating the configuration of a network system according to an embodiment of the present invention;

FIG. 2 is a block diagram showing the construction of an image input server according to this embodiment;

FIG. 3 is a schematic view showing the organization of various function modules in the image input server;

FIG. 4 is a diagram showing the organization of various function modules in a client apparatus;

FIG. 5 is a diagram illustrating the data structure of connection information concerning peripheral devices on a network according to this embodiment;

FIG. 6 is a diagram showing the data structure of functions which implement processing utilizing an image input device and other peripheral devices;

FIG. 7 is a flowchart illustrating tool-tip display processing according to this embodiment;

FIG. 8 is a diagram illustrating menu icons and the status of connections of machines and various peripheral devices that belong to a network; and

FIG. 9 is a diagram showing a tool-tip display according to this embodiment.

### DESCRIPTION OF THE PREFERRED EMBODIMENT

A preferred embodiment of the present invention will now be described in detail with reference to the drawings.

The configuration of the network system according to this embodiment will be described first.

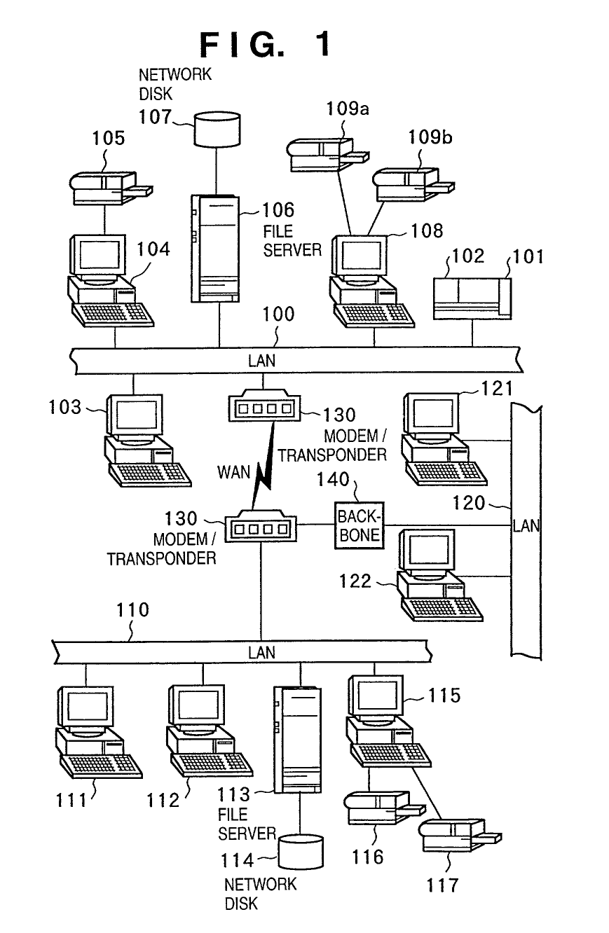

FIG. 1 is a diagram showing a case where a network board 101 for connecting printers to a network has been connected to a printer 102 having an open architecture. The network board 101 is connected to a local area network (LAN) 100 via a LAN interface such as an Ethernet interface 10Base-2 having a coaxial connector or a 10Base-T having an RJ-45, etc.

A plurality of personal computers 103, 104, etc., also are connected to the LAN 100 and are capable of communicating with the network board 101 under the control of an network operating system. Under these conditions, one of the personal computers, say, personal computer 103, can be designated so as to be used as a network management unit. Further, a peripheral device such as a printer 105 that has been connected to the personal computer 104, for example, may be connected to the personal computer 103.

Further, a file server 106 has been connected to the LAN 100 and manages access to files that have been stored in a large-capacity (e.g., 10-gigabyte) network disk 107. A print server 108 causes connected printers 109a, 109b or the remote printer 105, etc., to print. Other peripheral devices (not shown) may also be connected to the LAN 100.

The network shown in FIG. 1 is capable of using network software such as Novell or UNIX software in order that various interconnected networks may communicate with one another efficiently. It is possible to use any network software. For example, NetWare (a registered trademark of Novell), which is network software developed by Novell, can be used. For a detailed description of this network software, refer to the online documentation bundled with the NetWare package. This can be purchased from Novell together with the NetWare package.

The file server 106 shown in FIG. 1 performs the function of a file management unit for carrying out the reception, storage, queuing, caching and transmission of data files among the members connected to the LAN 100. For example, data files created by the personal computers 103, 104 are sent to the file server 106. The file server 106 arranges and stores these data files in order and, in accordance with a command from the print server 108, reads out the arranged data files and transmits them to the printer 109a.

Further, the personal computers 103 and 104 are ordinary personal computers which can generate data files and transmit the generated data files to the LAN 100 or which can receive data files from the LAN 100 and display and/or process these files. It should be noted that although personal computers are shown in FIG. 1, other types of computers suitable for the execution of network software may be included in the network. For example, in a case where UNIX software is being employed, UNIX workstations may be included in the network and these workstations can be used together with the illustrated personal computers under the appropriate conditions.

LANs such as the LAN 100 ordinarily provide service to several local user groups such as user groups on one or several successive floors in one building. A wide-area network (WAN) may be constructed in a case where certain users are separated from other users, as when some users are in another building or prefecture. A WAN basically is an aggregate formed by interconnecting several LANs by a high-speed digital line such as a high-speed Integrated Services Digital Network (ISDN) telephone line. Accordingly, as shown in FIG. 1, a WAN is formed by interconnecting the LAN 100, a LAN 110 and a LAN 120 via a modulator/demodulator (MODEM)/transponder 130 and a backbone 140. These connections are simple electrical connections by way of a several buses. It should be noted that each of these LANs includes dedicated personal computers and usually, though not necessarily, a file server and a print server.

Accordingly, as shown in FIG. 1, the LAN 110 includes personal computers 111, 112, a file server 113, a network disk 114, a printer server 115, and printers 116, 117. By contrast, the LAN 120 includes only personal computers 121 and 122. The devices that have been connected to each of the LANs 100, 110 and 120 are capable of accessing the functions of the devices of the other LANs via the WAN connection.

An example will now be described in which an image input device such as a scanner is connected to each of the personal computers 103, 104 shown in FIG. 1 and is connected to the network as an image input server.

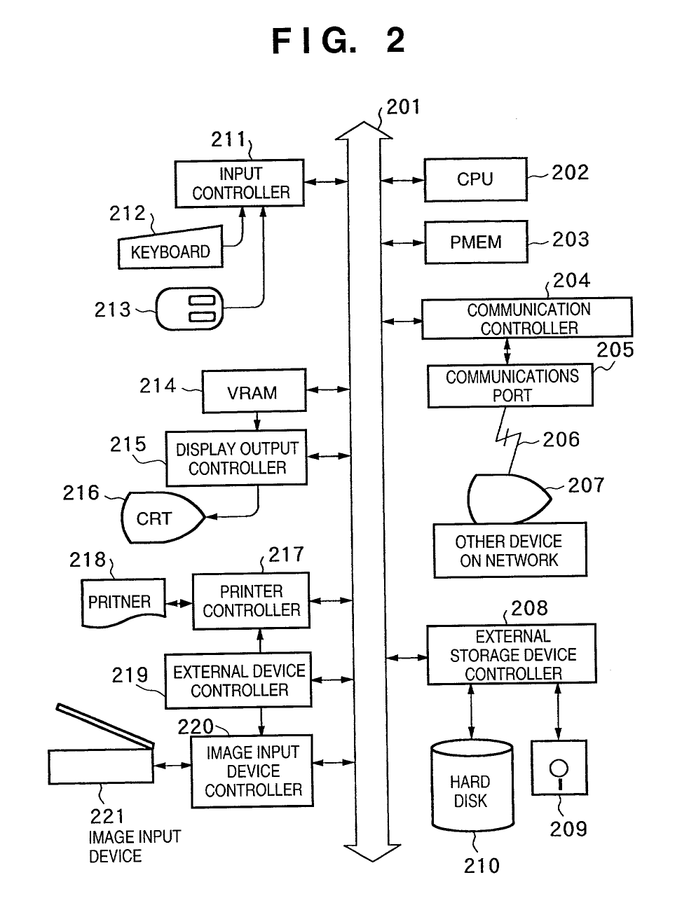

FIG. 2 is a block diagram illustrating the construction of an image input server according to this embodiment. As shown in FIG. 2, a system bus 201 connects various blocks, described later. A CPU (central processing unit) 202 controls the overall apparatus in accordance with a program, described later. A program memory (PMEM) 203 selects and reads in the program, which is to be executed by the CPU 202, from a hard disk 210, described later. It should be noted that the program memory 203 functions also as a text memory for storing, as code information, data that has been entered from a keyboard 212, described later.

A communication controller 204 controls data communication performed via a communication port 205. The communication port 205 has been connected to the communication port of another device on the network by a communication line 206. According to this embodiment, it is assumed that exchange of data among peripheral devices such as printers or scanners shared on the network is carried out via the communication controller 204. Further, though a network such as a LAN has been mentioned as the communication line 206, it goes without saying that the present invention is applicable even if the communication port 205 and communication line 206 connected to the communication controller 204 are constituted by an ordinary public telephone line.

An external storage device controller 208 controls access to data-file disks, namely a floppy disk (FD) 209 and a hard disk (HD) 210, by way of example.

An input controller 211 has input units such as the keyboard 213 and a pointing device 213 such as a mouse connected thereto. The operator operates the system by operating the input controller 211 and manipulates image information on a CRT 216 by operating the mouse 213. More specifically, by moving a cursor at will along the X and Y directions on the CRT 216, the operator selects command icons on a command menu to thereby designate processing, design editing objects and designate plot positions, etc.

A video image memory (VRAM) 214 stores bitmap data expanded for display purposes. A display output controller 215 outputs the bitmap data in VRAM 214 to the CRT 216. A printer controller 217 controls the output of data to a connected printer 218. An image input device controller 220 controls a connected image input device 221 such a scanner. An external device controller 219 controls the printer controller 217 and the image input device controller 220.

In a case where an image input device is connected and is used as an image input server, the image input device controller 220 and the image input device 221 are essential components. However, in case of an apparatus on the client side, such as the personal computer 103 or 104 shown in FIG. 1, the identical shared components on the server side can be used via the communication controller 204 and communication port 205 described above.

Further, the image input device 221 and image input device controller 220 may be arranged as physically separate components, as set forth above, or as a single component in which the image input device 221 contains the image input device controller 220.

The organization of modules for implementing the various functions related to the image input device of the image input server according to this embodiment will now be described.

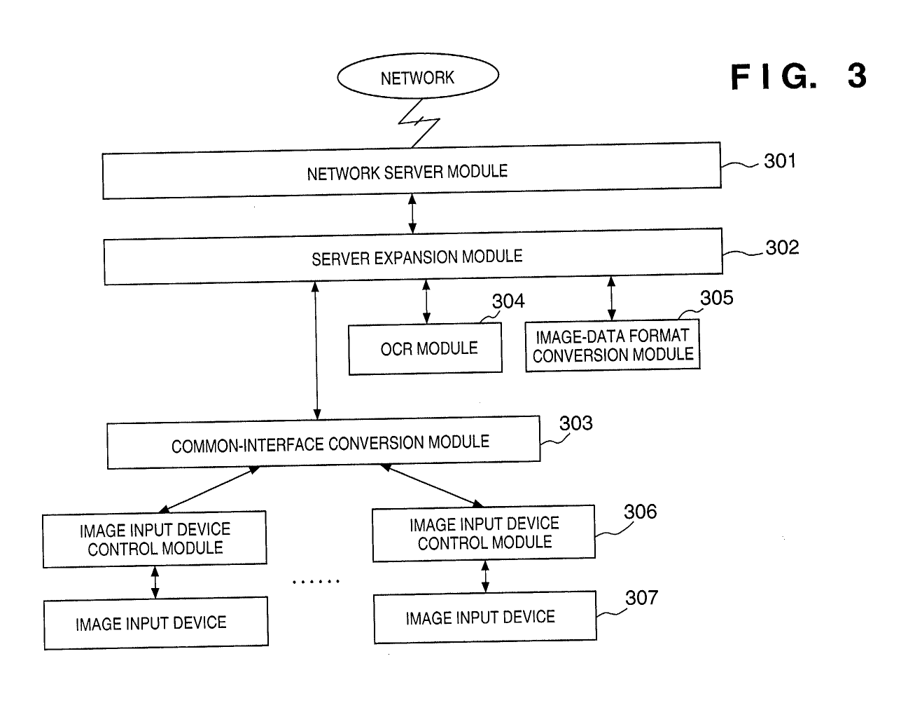

FIG. 3 is a schematic view illustrating the organization of various function modules in an image input server. A network server module 301 converts data, which has been received from a server expansion module 302, described later, to a data format capable of being exchanged over a network and corresponding to a general-purpose network protocol, and converts network data, which has been sent from a device on the client side, to an internal data format which the server expansion module is capable of interpreting.

The server expansion module 302 analyzes data that has been delivered from the network server module 301, selects whichever of a plurality of image server modules under the control of this module has been designated and provides the applicable service, or delivers data from a certain service module to another service module. For example, the server expansion module 302 performs an operation such as calling an image input device control module from an OCR module, described later.

In a case where the server expansion module 302 requests any image input device for provision of a service, a common-interface conversion module 303 effects a conversion to a command instruction corresponding to the module that controls the image input device to which the request was issued. Conversely, the common-interface conversion module 303 effects a conversion to an ordinary interface that delivers device-specific control information, which has been obtained from the module that controls an image input device, to the server expansion module 302. More specifically, the former information is image read-in parameter setting information from a client and the latter is image information and its accessory information obtained as a result of designating reading.

An OCR module 304 is called from the server expansion module 302 when a client requests that image data read by an image input device be converted to text data. An image-data format conversion module 305 converts the format of image data obtained from an image input device to an image data format designated by a client. An image input device control module 306 performs control conforming to the individual image input device 307. The image input device control module 306 inputs/outputs control instructions/information conforming to (specialized for) the particular device.

Described next will be the organization of modules which implement various functions for inputting image information from a locally connected image input device, and modules which implement various functions for inputting image information from an image input server connected via a network. These modules are located in an apparatus on the client side, such as the personal computers 103, 104 shown in FIG. 1.

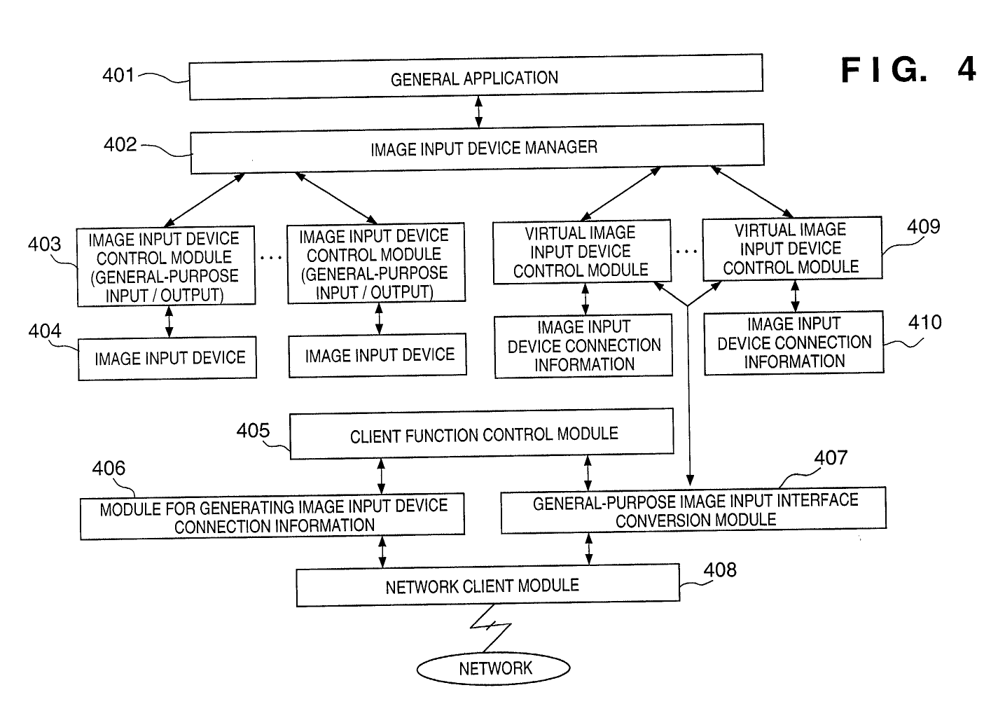

FIG. 4 is a diagram showing the organization of various function modules in a client apparatus. Modules 401 to 404 are necessary in order to access locally connected image input devices from a general application in the client apparatus. Specifically, numeral 401 denotes a general application that requires an input of image data, and 402 an image input device manager for providing the application 401 with a general-purpose image-input interface. The image input device manager 402 performs an exchange of information with whichever one of image input device control modules under its management has been designated in dependence upon a designation made by an image input interface.

An image input device control module 403 having a general-purpose input/output is for controlling an image input device individually connected by a general-purpose interface. The image input device is decided between the module 403 and the image input device manager 402. Further, the module 403 provides a general-purpose interface, unlike the image input device control module 306 shown in FIG. 3. That is, functionally speaking, the module 403 is a combination of the image input device control module 306, the common-interface conversion module 303 and a general-purpose image input interface conversion module, described later.

More specifically, the image input device manager 402 is a TWAIN (Technology Without Any Interested Name) manager, by way of example. The image input device control module 403 is equivalent to a TWAIN driver, which corresponds to an individual image input device. Individual image input devices 404 are locally connected to this apparatus.

A client function control module 405 is a module which performs overall management of modules for implementing client extensions, described later. A module 406 for generating image input device connection information acquires attribute information, which concerns peripheral devices that have been connected on the server side, obtained utilizing a network client module 408, described later, and information necessary for a network connection. The module 406 generates connection information 410 of individual image input devices. At the same time, the module 406 automatically generates control modules 409 of virtual image input devices. By generating these modules, the image input device manager 402 is capable of handling the network image input devices as if they were virtually connected. The connection information 410 of individual image input devices will be described later.

A general-purpose image input interface conversion module 407 converts control information regarding image input devices on the server side, which information has been obtained utilizing the network client module 408, to a general-purpose interface conforming to the image input device manager 402. The module 407 does not directly provide the image input device manager 402 with the functions possessed by these interfaces but provides them via the individual control modules 409 of the virtual image input devices, as will be described later.

The network client module 408 effects a conversion to a data format capable of being exchanged over a network and corresponding to a general-purpose network protocol in such a manner that each module mentioned above and modules on the server side can communicated.

The control modules 409 of the virtual image input devices are generated in a 1:1 ratio with respect to the set image input devices on the network. The control modules 409 basically perform only processing which intervenes in intermediate fashion, i.e., they send back corresponding image input device connection information 410 or deliver the same information to the general-purpose image input interface conversion module 407 and deliver the results to the image input device manager 402. As described above, the general-purpose image input interface conversion module 407 carries out the major portion of the actual processing. As a result, the modules 409 can be reduced in size and there is little overhead even if modules for a plurality of image input devices on the network are created.

It should be noted that this embodiment is described in regard to modules for generating connection information of image input devices, which have been connected locally or via a network, in a client apparatus. However, connection information of output devices on the network can also be generated by similarly constructed control modules for virtual output devices.

Described next will be the data structure of the connection information 410 of image input devices and the connection information of output devices (connection information of peripheral devices which exist on the network), which information is generated in the client apparatus.

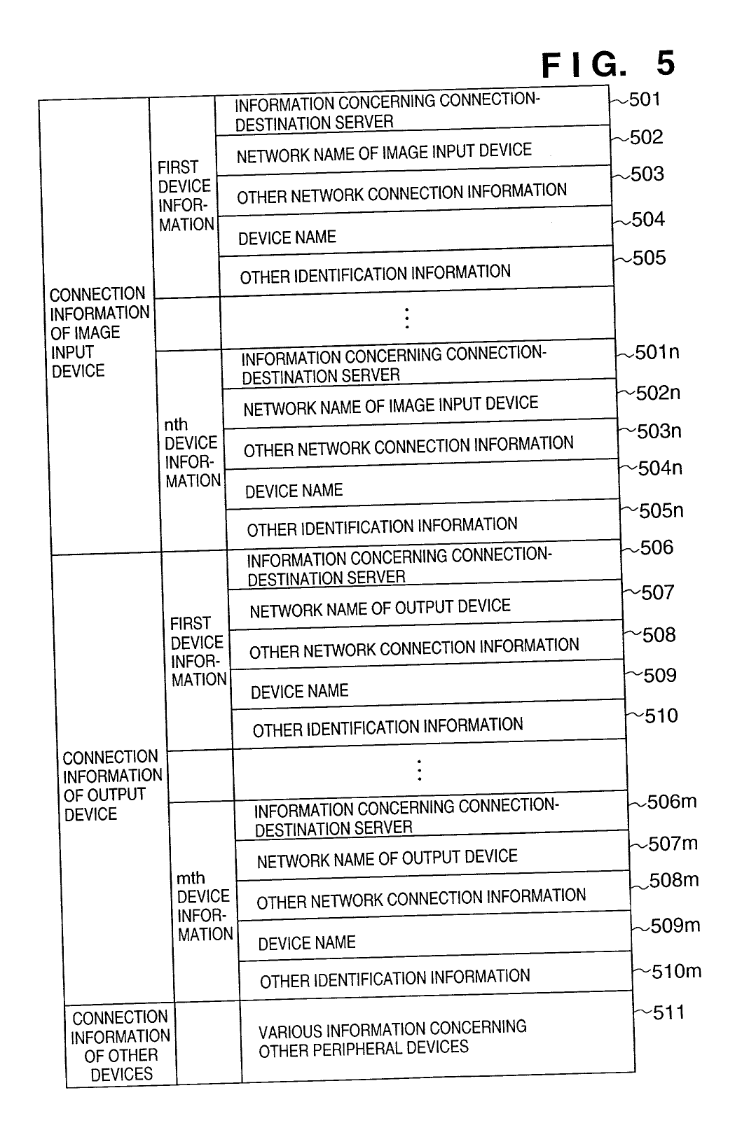

FIG. 5 is a diagram illustrating the data structure of connection information concerning peripheral devices on a network according to this embodiment. Numerals 501 to 505 denote information relating to one image input device capable of being utilized. These items of information have been read in from a server in relation to a device shared on the network. This is connection information concerning the user's own machine in regard to a device that has been connected to the user's own machine.

The information 501 is for identifying a server that is the destination of a connection on the network, i.e., a machine name or network address on the network. The information 502 is the network name of the utilizable image input device for identifying this device on the network. The information 503 is necessary for making a connection to other networks.

The information 504 and 505 is device identifying information for supplying virtual device information to the image input device manager 402 described above. Specifically, numeral 504 denotes device name information and 505 other identifying information.

In a case where a plurality of utilizable image input devices exist on the network, a plurality of items of information reside in the data structure in a manner similar to 501 to 505. This example illustrates a case where N-number of utilizable image input devices exist on the network. Numerals 501 to 505 and numerals 501n to 505n denote the respective items of information.

Numerals 506 to 510 denote items of information concerning one output device (e.g., a printer) that is capable of being utilized.

The information 506 is for identifying a server that is the destination of a connection on the network, i.e., a machine name or network address on the network. The information 507 is the network name of the utilizable output device (printer) for identifying this device on the network. The information 508 is necessary for making a connection to other networks. Numerals 509 and 510 denote device name information and other identifying information, respectively.

In a case where a plurality of utilizable output devices (printers, for example) exist on the network, a plurality of items of information reside in the data structure in a manner similar to 506 to 510. This example illustrates a case where M-number of utilizable output devices exist on the network. Numerals 506 to 510 and numerals 506m to 510m denote the respective items of information.

Numeral 511 denotes information indicating utilizable peripheral devices other than image input devices and output devices. In a case where a plurality of such utilizable devices exist on the network in a manner similar to the image input devices or output devices, a plurality of these items of information will reside in the data structure.

Described next will be management information for managing various functions such as image reading and copying executed utilizing the above-mentioned image input devices, output devices and other devices.

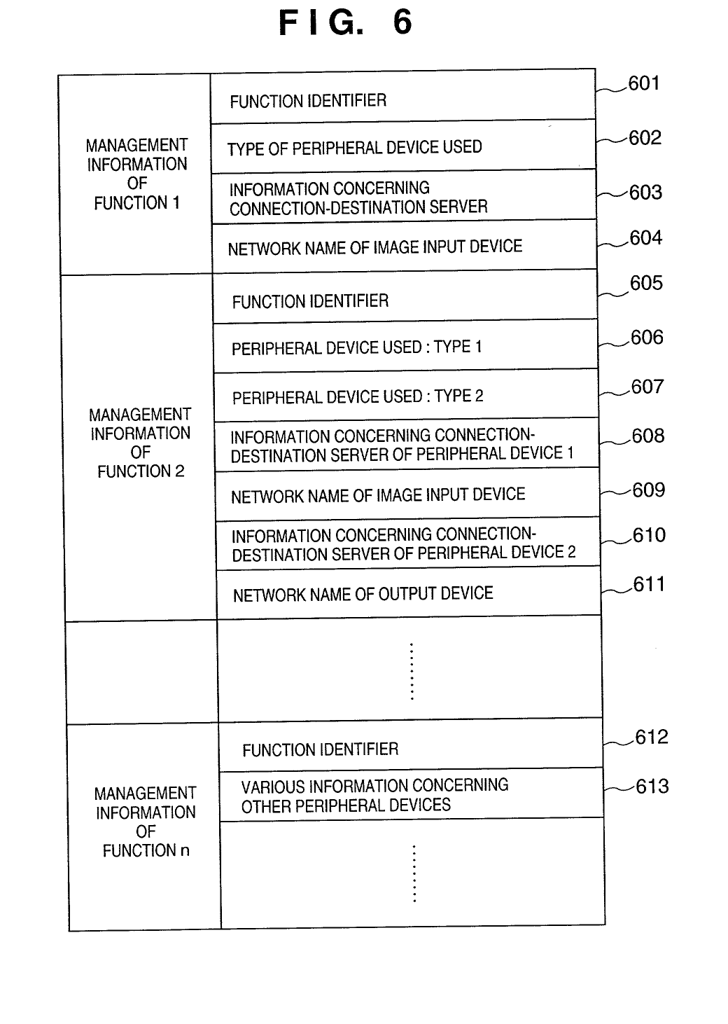

FIG. 6 is a diagram showing the data structure of functions which implement processing utilizing an image input device and other peripheral devices. Here numerals 601 to 604 denote management information of a function 1. This is an example of the data structure of management information in a function which utilizes an image input device and stores information that has been read. Specifically, a function identifier 601 decides the type of peripheral device (e.g., a scanner) used in processing. Numeral 602 denotes the type of peripheral device used. This indicates information concerning the type of peripheral device (a scanner in this case) decided by the function identifier 601. Numeral 603 denotes information concerning the server that is the destination of the connection. This is information for identifying the network server of the peripheral device used (the scanner in this case), the server being the destination of the connection. In other words, the machine name or network address thereof on the network is set as this information. Numeral 604 denotes the network name of the image input device configured for sharing on the network. This network name is for identifying the image input device on the network.

Numerals 605 to 611 denote management information of a function 2. This is an example of the data structure of management information in a function which utilizes an image input device and an output device and outputs data that has been read. A function identifier 605 decides the types of peripheral devices (e.g., a scanner and a printer) used in processing. This is similar to the identifier 601. Numerals 606 and 607 denote the types of peripheral devices used. This is information concerning the types of peripheral devices (a scanner and printer in this case) decided by the function identifier 605. Numeral 608 denotes information concerning the server that is the destination of the connection of peripheral device 1. This is information for identifying the network server of the peripheral device 1 used (the scanner in this case), the server being the destination of the connection. In other words, the machine name or network address thereof on the network is set as this information. Numeral 609 denotes the network name of the image input device configured for sharing on the network. This network name is for identifying the image input device on the network. Numeral 610 denotes the type of server that is the destination of the connection of peripheral device 2. This is information for identifying the network server of the peripheral device 2 used (the printer in this case), the server being the destination of the connection. In other words, the machine name or network address thereof on the network is set as this information. Numeral 611 denotes the network name of this output device configured for sharing on the network. This network name is for identifying the output device on the network.

Numerals 612, 613 denote management information of a function n. These items of information similarly represent data structure in a case where there are a plurality of types of peripheral devices utilized. Numeral 612 denotes the identifier of the nth function, and numeral 613 sets one or a plurality of types of information groups of a peripheral device used. Thus, settings information such as the type of peripheral device which executes each function and information concerning the connection destination server is set on a per-function basis. As a result, settings information can be managed universally even if the type of function for executing a function and the type of peripheral device are changed or supplemented.

Described next will be display processing at an apparatus on the client side for displaying, in the form of tool tips (described later), settings information of functions implemented by image input devices, output devices and other peripheral devices connected to the network in the arrangement set forth above.

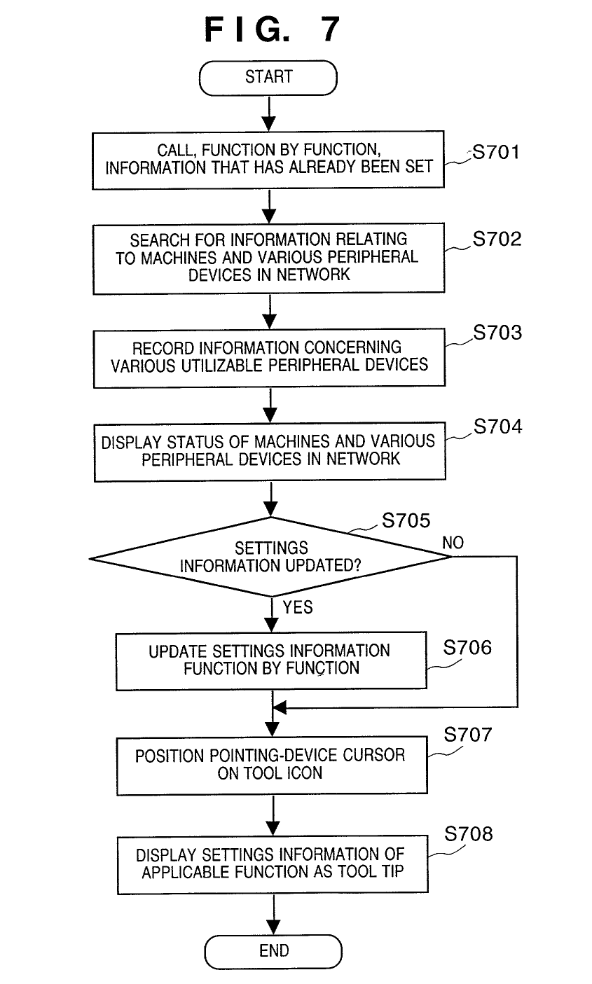

FIG. 7 is a flowchart illustrating tool-tip display processing according to this embodiment. This processing is implemented by having the CPU 202 execute a program that has been stored in the program memory 203.

First, at step S701, settings information concerning an image input device or output device, etc., desired to be utilized, which information has been established for each function, is called. More specifically, information concerning a peripheral device desired to be utilized is called from the management information of each function illustrated in FIG. 6. Next, information relating to the machines and various peripheral devices belonging to the network is searched for at step S702. Here the peripheral-device connection information shown in FIG. 5 is searched to acquire each item of information. This is followed by step S703, at which the information concerning the various utilizable peripheral devices is recorded from the items of information acquired by the search.

On the basis of the various items of information acquired at step S702, the configuration information concerning the machines and various peripheral devices in the network is displayed at step S704.

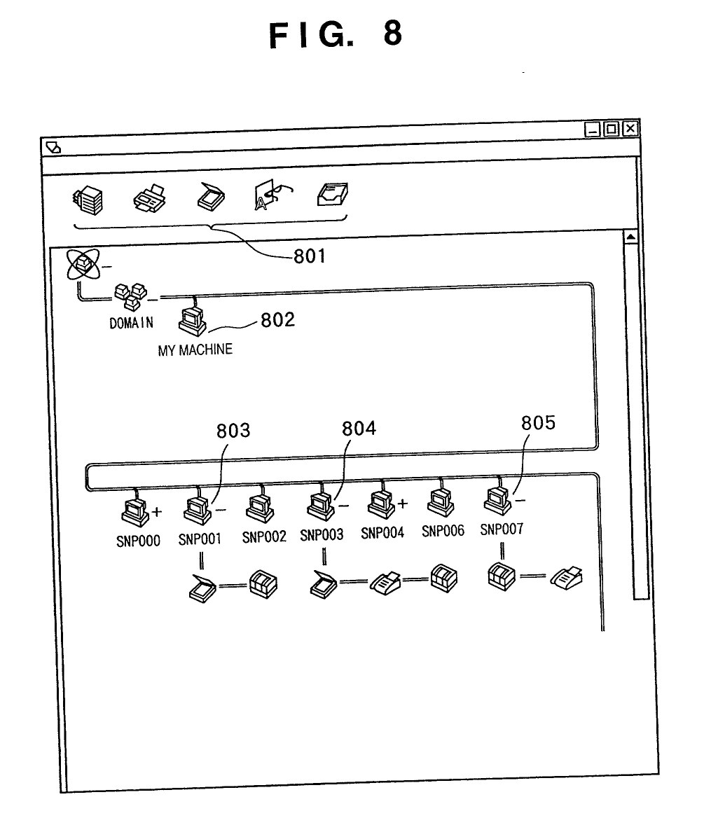

FIG. 8 is a diagram illustrating menu icons and the status of connections of machines and various peripheral devices that belong to a network. A menu icon 801 in FIG. 8 is composed of tool icons for implementing various functions, such as copy, facsimile, scan and OCR functions. Numeral 802 denotes a client apparatus and numerals 803, 804 and 805 represent peripheral devices connected to certain machines.

A “+” to the right of a machine is a symbol indicating a state in which peripheral devices have been connected to the machine, and a “−” to the right of a machine is a symbol signifying that the connected peripheral devices are being displayed.

With reference again to FIG. 7, the user performs an operation at step S705 to determine whether the settings information of each function has been updated from the state of step S701. If the settings information has not been updated, control proceeds to step S707. If the settings information has been updated, then control proceeds to step S706, at which information update processing is applied to the settings information called at step S701.

If the user places a mouse or other pointing-device cursor on a function-implementing tool icon for a fixed period of time at step S707, control proceeds to step S708, at which a tool tip that includes settings information of this function is displayed in the proximity of the tool icon designated.

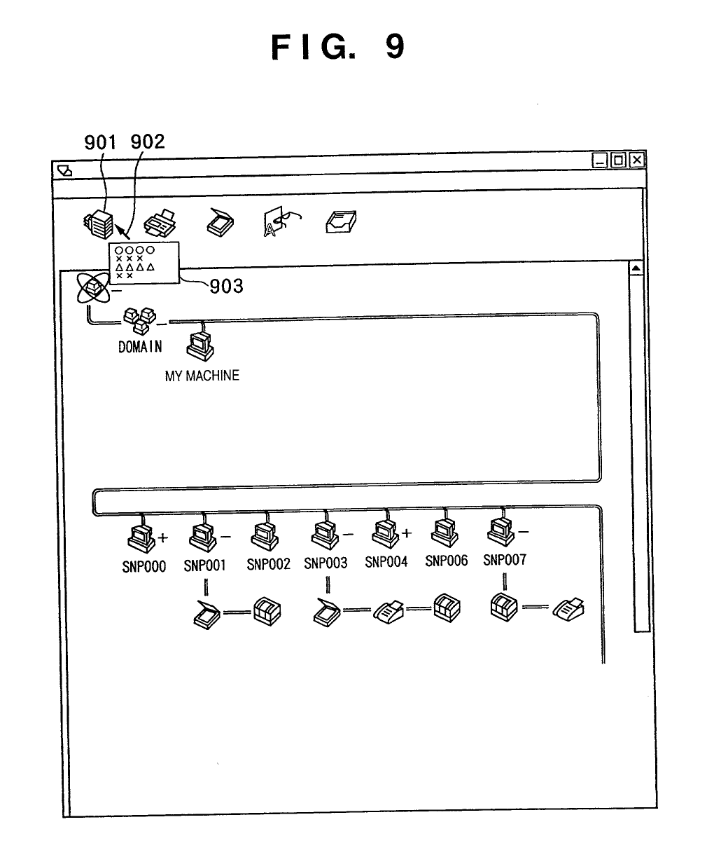

FIG. 9 is a diagram showing a tool-tip display according to this embodiment. Here it is assumed that the content displayed by this tool tip displays some or all of the management information of each function shown in FIG. 6. In the example depicted in FIG. 9, a tool tip 903 is displayed in the proximity of tool icon 901 (e.g., function 2 in FIG. 6) if a pointing-device cursor 902 is placed on the tool icon 901 for a fixed period of time.

An example of the content displayed in tool tip 903 is “NETWORK NAME OF IMAGE INPUT DEVICE” (609), “INFORMATION CONCERNING CONNECTION-DESTINATION SERVER OF PERIPHERAL DEVICE 1” (608), “NETWORK NAME OF OUTPUT DEVICE” (611), and “INFORMATION CONCERNING CONNECTION-DESTINATION SERVER OF PERIPHERAL DEVICE 2” (610).

Thus, in accordance with this embodiment, function-by-function settings information of various peripheral devices, which information has been set in a client apparatus in a network system composed of an image input server and a client on a network, is displayed in the form of tool tips. As a result, settings information of various peripheral devices set on a per-function basis can readily be displayed without displaying various settings screens.

The present invention can be applied to a system constituted by a plurality of devices (e.g., a host computer, interface, reader, printer, etc.) or to an apparatus comprising a single device (e.g., a copier or facsimile machine, etc.).

Furthermore, it goes without saying that the object of the invention is attained also by supplying a storage medium storing the program codes of the software for performing the functions of the foregoing embodiment to a system or an apparatus, reading the program codes with a computer (e.g., a CPU or MPU) of the system or apparatus from the storage medium, and then executing the program codes.

In this case, the program codes read from the storage medium implement the novel functions of the embodiment, and the storage medium storing the program codes constitutes the invention.

Further, the storage medium for supplying the program code can employ a floppy disk, hard disk, optical disk, magneto-optical disk, CD-ROM, CD-R, magnetic tape, non-volatile type memory card or ROM.

Furthermore, besides the case where the aforesaid functions according to the embodiment are implemented by executing the program codes read by a computer, it goes without saying that the present invention covers a case where an operating system or the like running on the computer performs a part of or the entire process in accordance with the designation of program codes and implements the functions according to the embodiment.

It goes without saying that the present invention further covers a case where, after the program codes read from the storage medium are written in a function expansion board inserted into the computer or in a memory provided in a function expansion unit connected to the computer, a CPU or the like contained in the function expansion board or function expansion unit performs a part of or the entire process in accordance with the designation of program codes and implements the function of the above embodiment.

Thus, in accordance with the present invention, as described above, it is possible to provide greater user convenience by displaying, function by function and without performing a complicated operation, the settings information of peripheral devices connected on a network.

As many apparently widely different embodiments of the present invention can be made without departing from the spirit and scope thereof, it is to be understood that the invention is not limited to the specific embodiments thereof except as defined in the appended claims.

What is claimed is:

1. A network terminal apparatus comprising:
search means for finding the connection status of each of various peripheral devices connected to a network;
management means for managing settings information of a peripheral device for each function implemented by the peripheral device, based upon the connection status found by said search means;
icon display means for displaying, in icon form, each function managed by said management means; and
settings information display means for displaying settings information concerning a peripheral device in regard to a function selected by a user from among the functions displayed by said icon display means.

2. The apparatus according to claim 1, wherein said management means manages, function by function, a peripheral device which the user desires to utilize.

3. The apparatus according to claim 1, wherein said icon display means displays each function in the form of a menu.

4. The apparatus according to claim 1, wherein said settings information display means displays at least information relating to the type of peripheral device, a network name of the peripheral device and a connection-destination server thereof as the settings information of the peripheral device.

5. The apparatus according to claim 1, further comprising designating means for allowing the user to designate, in order to select, a desired function from among the functions displayed by said icon display means;
wherein when an icon display of a desired function is designated for a predetermined period of time by said designating means, said settings information display means displays settings information of the peripheral device in regard to this desired function in the proximity of the icon display.

6. A method of presenting a display on a network terminal apparatus, the method comprising:
a search step of finding the connection status of each of various peripheral devices connected to a network;
a management step of managing settings information of a peripheral device for each function implemented by the peripheral device, based upon the connection status found at said search step;
an icon display step of displaying, in icon form, each function managed at said management step; and
a settings information display step of displaying settings information concerning a peripheral device in regard to a function selected by a user from among the functions displayed at said icon display step.

7. The method according to claim 6, wherein said management step manages, function by function, a peripheral device which the user desires to utilize.

8. The method according to claim 6, wherein said icon display step displays each function in the form of a menu.

9. The method according to claim 6, wherein said settings information display step displays at least information relating to the type of peripheral device, a network name of the peripheral device and a connection-destination server thereof as the settings information of the peripheral device.

10. The method according to claim 6, further comprising a designating step of allowing the user to designate, in order to select, a desired function from among the functions displayed at said icon display step;
wherein when an icon display of a desired function is designated for a predetermined period of time at said designating step, said settings information display step displays settings information of the peripheral device in regard to this desired function in the proximity of the icon display.

11. A computer-readable storage medium storing program codes of a method of presenting a display on a network terminal apparatus, said storage medium comprising the codes of:
a search step of finding the connection status of each of various peripheral devices connected to a network;
a management step of managing settings information of a peripheral device for each function implemented by the peripheral device, based upon the connection status found at said search step;
an icon display step of displaying, in icon form, each function managed at said management step; and
a settings information display step of displaying settings information concerning a peripheral device in regard to a function selected by a user from among the functions displayed at said icon display step.

12. The storage medium according to claim 11, wherein the code of said management step manages, function by function, a peripheral device which the user desires to utilize.

13. The storage medium according to claim 11, wherein the code of said icon display step displays each function in the form of a menu.

14. The storage medium according to claim 11, wherein the code of said settings information display step displays at least information relating to the type of peripheral device, a network name of the peripheral device and a connection-destination server thereof as the settings information of the peripheral device.

15. The storage medium according to claim 11, further comprising code of a designating step of allowing the user to designate, in order to select, a desired function from among the functions displayed in the form of icons;
wherein when an icon display of a desired function is designated for a predetermined period of time by the code of said designating step, the code of said settings information display step displays settings information of the peripheral device in regard to this desired function in the proximity of the icon display.
